(19) United States
(12) Patent Application Publication
(10) Pub. No.: US 2022/0298843 A1
(43) Pub. Date: Sep. 22, 2022

(54) SWITCH HINGE STRUCTURE USED IN DOOR OF VEHICLE

(71) Applicants: HYUNDAI MOTOR COMPANY, Seoul (KR); Kia Corporation, Seoul (KR)

(72) Inventor: Kui Chao LV, Yantai (CN)

(73) Assignees: HYUNDAI MOTOR COMPANY, Seoul (KR); Kia Corporation, Seoul (KR)

(21) Appl. No.: 17/497,265

(22) Filed: Oct. 8, 2021

(30) Foreign Application Priority Data
Mar. 17, 2021 (CN) 202110285817.8

(51) Int. Cl. E05F 11/54

(52) U.S. Cl. CPC E05F 11/54; E05Y 2201/474; E05Y 2201/484; E05Y 2201/716; E05Y 2900/534

(57) ABSTRACT

A switch hinge structure used for a charging door or a fuel door of a vehicle includes: a structure housing having an inner wall on which a first boss is disposed; a guide member concentrically installed in the structure housing, and having a groove track on an outer wall thereof; a first spring installed in the structure housing to provide thrust to the guide member in a direction toward an outside of the vehicle; a rotation member installed on an end of the structure housing, having an annular shape, and having a second boss on an interior circumference thereof; and a second spring providing torque to the guide member through the second boss. The first and second bosses are accommodated in the groove track, and guide movement of the guide member when the guide member moves out of the vehicle by an action of the first and second springs.

### CROSS-REFERENCE TO RELATED APPLICATION

This application claims the benefit of priority to Chinese Patent Application No. 202110285817.8 filed on Mar. 17, 2021 in the Chinese National Intellectual Property Administration, the entire contents of which are incorporated herein by reference.

### TECHNICAL FIELD

The present disclosure relates to a door of a vehicle, particularly, a switch hinge structure used in a charging door or a fuel door.

### BACKGROUND

New energy vehicles such as electric vehicles (EVs) and hybrid electric vehicles (HEVs) have been widely used. Since a new energy vehicle needs to be recharged frequently, the use of a charging door switch of the vehicle is correspondingly increasing frequently.

However, a hinge structure of the charging door (or fuel door) switch in the related art uses a single spring pop-up structure. Therefore, when the charging door is opened by pressing, the spring force is too large such that an excessive pop-up force of the charging door is generated and the rotation speed becomes too fast. In addition, when closing the charging door (or fuel door), a large amount of pressure must be applied, and a user must use a relatively large force to close the charging door (or fuel door), which may make the user feel inconvenient to use.

Therefore, there is a need to develop a switch hinge structure used for the charging door or the fuel door of the vehicle to reduce a malfunction rate, to smoothly open and close the charging door (or fuel door), and to significantly improve the user's convenience.

The above information disclosed in this Background section is only for enhancement of understanding of the background of the disclosure, and therefore it may contain information that does not form the prior art that is already known in this country to a person of ordinary skill in the art.

### SUMMARY

An embodiment of the present disclosure is to provide a switch hinge structure used in a charging door or a fuel door of a vehicle.

According to an embodiment of the present disclosure, a switch hinge structure used for the charging door or the fuel door of a vehicle is disclosed. The switch hinge structure used for the charging door or the fuel door of the vehicle includes: a structure housing having an inner wall on which at least one first boss is disposed; a guide member installed in the structure housing concentrically with the structure housing, and including a first end disposed close to a first end portion of the structure housing, a second end connected to a cover of the charging door or the fuel door, and a groove track defined on an outer wall of the guide member; a first spring installed in the structure housing to provide thrust to the guide member in a direction toward an outside of the vehicle; a rotation member installed on a second end portion of the structure housing, having an annular shape, and having at least one second boss on an interior circumference thereof; and a second spring connected to the rotation member, being in an energy storage state when the charging door or the fuel door is closed, and configured to drive the rotation member to provide torque to the guide member through the second boss when the charging door or the fuel door is opened. The first boss and the second boss are accommodated in and coupled with the groove track, and are configured to guide a movement of the guide member when the guide member moves out of the vehicle by an action of the first spring and the second spring.

In some embodiments, the first spring may be configured such that, when an elastic force of the first spring acts independently, the elastic force is set to be not sufficient to cause the guide member to move farthest from the first end using a guide of the groove track. When the guide member moves farthest from the first end along the groove track, the charging door or the fuel door may be fully opened. The first and second springs may be configured such that, when the elastic force of the first spring and an elastic force of the second spring act together, the guide member is set to move farthest from the first end using the guide of the groove track. As such, an opening process of the charging door or the fuel door connected to the guide member becomes smoother.

In some preferable embodiments, the first spring may be a compression spring, an elastic coefficient of the first spring may range from 20 to 25 gf·mm, and a compression length of the first spring may range from 80 to 120 mm. The “compression length” of the first spring is a difference between the length of the first spring when the charging door is in the open state and the length of the first spring when the charging door is in the closed state.

The second spring may be a torsion spring, and an elastic coefficient corresponding to a torsion angle of each 1° may range from 35 to 45 gf·mm.

In some embodiments, the groove track includes a straight track and a spiral track, the straight track extends from a position close to the second end of the guide member on a side of the guide member to a position close to the first end of the guide member, and the spiral track extends spirally from the straight track to the first end of the guide member. The rotation member is disposed at the second end of the structure housing. That is, in an inner space of the structure housing, the second boss is closer to the second end of the guide member than the first boss (or closer to the second end of the structure housing), when the guide member moves while the first boss and the second boss are disposed on the straight track, an angle between the first boss and the second boss is 0° (when observed from the second end of the structure housing), and when the guide member moves while at least one of the first boss and the second boss is disposed on the spiral track, the first boss on the inner wall of the structure housing does not move (i.e., the structure housing 2 and the first boss 24 are continuously fixed and still state), and the angle between the first boss and the second boss changes according to a rotation of the rotation member (when observed from the second end of the structure housing).

In one example, the straight track is longer than the spiral track. In the process of opening the charging door or the fuel door, the guide member connected to the cover of the charging door or the fuel door first moves in a straight line to the outside of the vehicle, and then rotates spirally to open the charging door or the fuel door. The straight track is formed longer than the spiral track to ensure that it has sufficient space with surrounding members in the process of opening the cover of the charging door or the fuel door, thereby preventing collision or scratching with the surrounding members.

In some embodiments, the switch hinge structure used for the charging door or the fuel door of the vehicle further includes a structure housing cover and a damping member, and the damping member is fixed to the structure housing cover and is coupled to the rotation member to control a rotation speed of the guide member.

In one example, teeth are disposed on a part of an exterior circumference of the rotation member, the damping member is a pinion gear type rotation damper including a pinion gear, and the teeth are combined with the rotation damper to adjust the rotation speed of the rotation member, thereby adjusting the rotation speed of the guide member. When the rotation member and the damping member are combined, the rotation speed of the guide member can be better adjusted, and thus the opening and closing process of the charging door or the fuel door becomes smoother.

In some embodiments, the switch hinge structure used for the charging door or the fuel door of the vehicle further includes a position limiting member, and the position limiting member defines a final position after the guide member moves. Specifically, the position limiting member is mounted in a position limiting member mount hole defined on the structure housing cover, an arc-shaped groove is included in the rotation member, and the arc-shaped groove is coupled with the position limiting member to define an initial position and a final position of the rotation member to thereby define the final position after the movement of the guide member.

The position limiting member may effectively prevent excessive rotation of the guide member, or when the guide member has completed the movement and the charging door is already in the open position (generally the guide member rotates 80° to 120°), additional rotation of the charging door can be prevented if there is a possibility that an external force is applied to the charging door.

In some embodiments, the switch hinge structure further includes a locking and unlocking member, the locking and unlocking member is installed at the first end of the structure housing, when the charging door or the fuel door is closed, the locking and unlocking member is in a locked state, and when the charging door or the fuel door is to be opened, the locked state of the locking and unlocking member is released, and the guide member starts to move toward the outside of the vehicle.

The locking and unlocking member may be a mechanical locking and unlocking member operated by an external pressure of the vehicle, may be a locking and unlocking member operated by control of a controller of the vehicle, or there is no special restriction as long as the purpose of unlocking is reached.

The effect of the present disclosure is not limited to the above, and in addition to the beneficial effect, in the detailed description of an embodiment of the present disclosure, the effect obtained or expected by applying an embodiment of the present disclosure is explicitly stated or will be implicitly disclosed. That is, various effects that can be predicted by applying an embodiment of the present disclosure in the detailed description provided below are disclosed.

### BRIEF DESCRIPTION OF THE DRAWINGS

FIG. 1 is a schematic diagram of a switch hinge structure used for a charging door or a fuel door, and the charging door or the fuel door according to an exemplary embodiment of the present disclosure.

FIG. 2 is a schematic exploded view of the switch hinge structure used for the charging door or the fuel door of the vehicle according to an exemplary embodiment of the present disclosure.

FIG. 3 is a schematic diagram of a part of the switch hinge structure used for the charging door or the fuel door of the vehicle according to an exemplary embodiment of the present disclosure.

FIG. 4A and FIG. 4B are schematic diagrams that illustrate a part of the switch hinge structure used for the charging door or the fuel door of the vehicle according to an exemplary embodiment of the present disclosure.

FIG. 5B, FIG. 5B and FIG. 5C are schematic diagrams that illustrate a part of the switch hinge structure used for the charging door or the fuel door of the vehicle according to an exemplary embodiment of the present disclosure.

### DETAILED DESCRIPTION OF THE EMBODIMENTS

The above-stated contents and other objects, features, and merit of the present disclosure will be more clearly understood through an embodiment described with reference to the drawings. However, the present disclosure is not limited to the disclosed embodiment, and may be changed into other forms. Such an embodiment is provided to fully explain the present disclosure and to fully convey the gist of the present disclosure to those skilled in the art.

For reference, terms such as “include”, “inclusive”, and “comprising” used in the specification are intended to designate the existence of a feature, number, step, action, element, component or combination thereof, and one or more other, and it is not intended to exclude the presence or addition of features, figures, steps, operations, elements, components, or combinations thereof. In addition, when a part, such as a layer, film, region, or plate, is “on” another part, it includes not only the case where it is “directly on” the other part, but also the case where there is another part in between. Conversely, when a part, such as a layer, film, region, or plate, is “under” another part, it includes not only the case where the other part is “directly under” but also the case where there is another part in between.

It should be understood that terms such as “vehicle” or “of vehicle” or other similar terms used in this specification generally include vehicles, and include for example, vehicles such as sport utility vehicles (SUV), public vehicles, trucks, and various commercial vehicles, include various boats, ships, aircraft, and the like, include hybrid vehicles, electric vehicles, pluggable hybrid electric vehicles, hydrogen vehicles, and other alternative fuel vehicles (e.g., fuel derived from energy sources other than gasoline).

Hereinafter, an exemplary embodiment of the present disclosure will be described in detail.

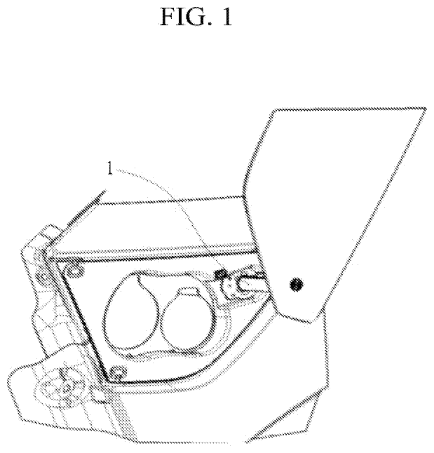

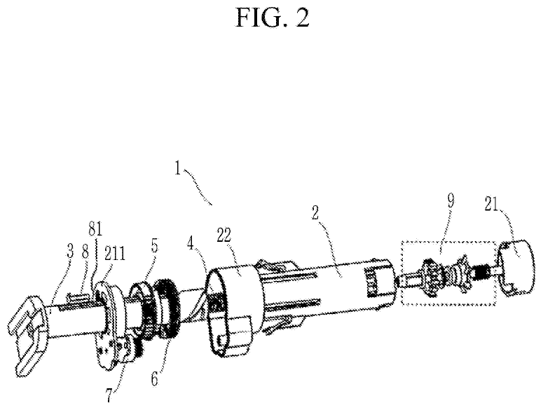

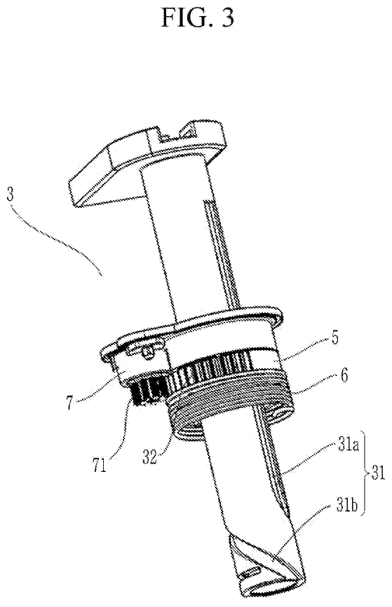

FIG. 1 is a schematic diagram of a switch hinge structure used for a charging door or a fuel door, and the charging door or the fuel door according to an exemplary embodiment of the present disclosure. FIG. 2 is a schematic exploded view of the switch hinge structure used for the charging door or the fuel door of the vehicle according to an exemplary embodiment of the present disclosure. FIG. 3 is a schematic diagram of a part of the switch hinge structure used for the charging door or the fuel door of the vehicle according to an exemplary embodiment of the present disclosure.

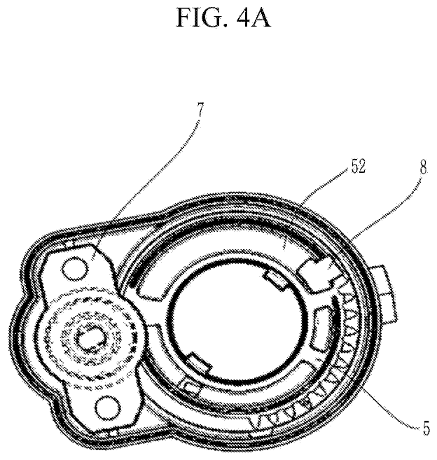

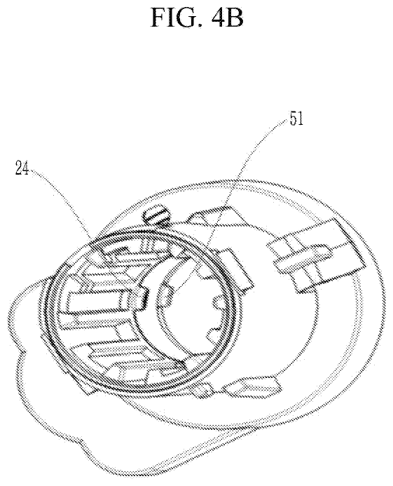

FIG. 4A and FIG. 4B are schematic diagrams that illustrate a part of the switch hinge structure used for the charging door or the fuel door of the vehicle according to an exemplary embodiment of the present disclosure, when the charging door or the fuel door is in a closed state.

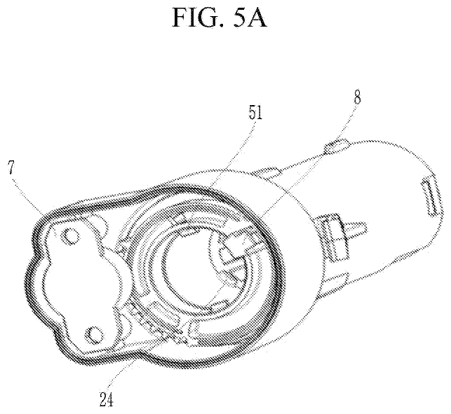

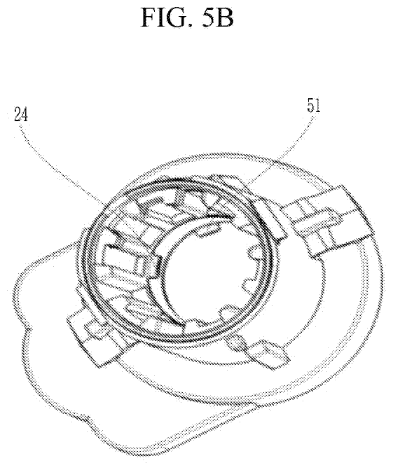

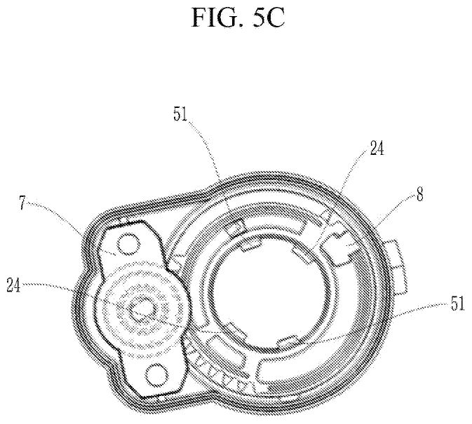

FIG. 5A, FIG. 5B and FIG. 5C are schematic diagrams that illustrate a part of the switch hinge structure used for the charging door or the fuel door of the vehicle according to an exemplary embodiment of the present disclosure, when the charging door or the fuel door is completely opened.

Referring to FIG. 1 to FIG. 5C, a switch hinge structure 1 used for a charging door or a fuel door of a vehicle is provided. The switch hinge structure 1 used for the charging door or the fuel door of the vehicle includes: a structure housing 2 where at least one first boss 24 is disposed in an inner wall; a guide member 3 installed in the structure housing 2 to have the same center as the structure housing 2, and including a first end disposed close to a first end portion 21 of the structure housing 2, a second end connected to a cover of the charging door or the fuel door, and a groove track 31 defined on an outer wall; a first spring 4 installed in the structure housing 2 to provide thrust to the guide member 3 in a direction toward an outside of the vehicle; a rotation member 5 installed on a second end portion 22 of the structure housing 2, having an annular shape, and having at least one second boss 51 on an interior circumference thereof; and a second spring 6 connected to the rotation member 5, being in an energy storage state when the charging door or the fuel door is closed, and driving the rotation member 5 to provide torque to the guide member 3 through the second boss 51 when the charging door or the fuel door is opened, wherein the first boss 24 and the second boss 51 are coupled with the groove track 31 and thus guide a movement of the guide member 3 when the guide member 31 moves out of the vehicle by the action of the first spring 4 and the second spring 6.

In the embodiment of the present disclosure, when an elastic force of the first spring 4 acts independently, the elastic force is not sufficient to cause the guide member 3 to move farthest from the first end 21 using the guide of the groove track 31. When the guide member 3 moves farthest from the first end 21 using the guide of the groove track 31, the charging door or the fuel door can be fully opened. Therefore, the elastic force of the first spring 4 and the elastic force of the second spring 6 are set such that the guide member 3 moves farthest from the first end 21 using the guide of the groove track 31 only when the elastic force of the first spring 4 and the elastic force of the second spring 6 act on the guide member 3 together, and thus an opening process of the charging door or the fuel door connected to the guide member 3 becomes smooth.

The first spring 4 is a compression spring, and an elastic coefficient of the first spring 4 may range from 20 to 25 gf·mm, and a compression length of the first spring may range from 80 to 120 mm. The “compression length” of the first spring 4 is a difference between a length of the first spring 4 when the charging door is in the open state and a length of the first spring 4 when the charging door is in the closed state. In the present embodiment, the elastic coefficient of the first spring 4 is about 22.82 gf·mm, a spring free length of the first spring 4 is about 150 mm, and a spring length of the first spring 4 when the charging door is in the closed state is about 48.8 mm. That is, the compression length of the first spring 4 is about 101.2 mm.

The second spring 6 is a torsion spring, and an elastic coefficient corresponding to a torsion angle of 1° may range from 35 to 45 gf·mm. In the present embodiment, the elastic coefficient of the second spring 6 corresponding to the torsion angle of each 1° is about 40.82 gf·mm.

The groove track 31 includes a straight track 31a and a spiral track 31b, the straight track 31a extends from a position close to the second end of the guide member 3 on a side of the guide member 3 to a position close to the first end of the guide member 3, and the spiral track 31b extends spirally from the straight track 31a to the first end of the guide member 3. The rotation member 5 is disposed at the second end portion 22 of the structure housing 2. That is, the second boss 51 is closer to the second end of the guide member 3 (or closer to the second end of the structure housing) than the first boss 24 in an inner space of structure housing 2. When the guide member 3 moves while the first boss 24 and the second boss 51 are disposed on the straight track 31a, an angle between the first boss 24 and the second boss 51 is 0° (refer to FIG. 4A which shows observation from the second end portion 22 of the structure housing). When the guide member 3 moves while at least one of the first boss 24 and the second boss 51 is disposed on the spiral track 31b, the first boss 24 on the inner wall of structure housing 2 does not move (the structure housing 2 and the first boss 24 are still stationary), but according to the rotation of the rotation member 5, the angle of the second boss 51 with respect to the first boss 24 changes. Generally, the guide member 3 rotates 80° to 120° (refer to FIG. 5C which shows observation from the second end portion 22 of the structure housing).

The straight track 31a is longer than the spiral track 31b in an axial direction of the guide member 3. In the process of opening the charging door or the fuel door, the guide member 3 connected to the cover of the charging door or the fuel door first moves in a straight line to the outside of the vehicle, and then rotates spirally to open the charging door or the fuel door. The straight track 31a is formed longer than the spiral track 31b to ensure that it has sufficient space with the surrounding member in the process of opening the cover of the charging door or the fuel door, thereby preventing collision or scratching with the surrounding member.

The switch hinge structure 1 used for the charging door or the fuel door of the vehicle further includes a structure housing cover 211 and a damping member 7, and the damping member 7 is fixed to the structure housing cover 211 and is coupled to the rotation member 5 to adjust the rotation speed of the guide member 3.

Teeth 32 are defined on a part of an exterior circumference of the rotation member 5, the damping member 7 is a pinion gear type rotation damper including a pinion gear 71, and the teeth are combined with the rotation damper to adjust the rotation speed of the rotation member 5, thereby adjusting the rotation speed of the guide member 3. When the rotation member 5 and the damping member 7 are combined, the rotation speed of the guide member 3 can be better adjusted, and thus the opening and closing process of the charging door or the fuel door becomes smoother.

The switch hinge structure 1 used for the charging door or the fuel door of the vehicle further includes a position limiting member 8, and the position limiting member 8 defines a final position after the guide member 3 moves. Specifically, the position limiting member 8 is mounted in a position limiting member mount hole 81 on the structure housing cover 211, an arc-shaped groove 52 is defined in the rotation member 5, and the arc-shaped groove 52 is coupled with the position limiting member 8 to define an initial position and a final position of the rotation member 5 (the initial position of rotation and the final position after rotation on the same plane), to thereby define a final position after the movement of the guide member 3 (moving to the outside in a straight line and then rotating in a spiral).

The position limiting member 8 effectively prevents excessive rotation of the guide member 3, or when the guide member 3 has completed the movement and the charging door is already in the open position (generally the guide member rotates 80° to 120°), additional rotation of the charging door can be prevented if there is a possibility that an external force is applied to the charging door.

The switch hinge structure 1 used for the charging door or the fuel door of the vehicle further includes a locking and unlocking member 9, and the locking and unlocking member 9 is installed at the first end 21 of the structure housing 2 (a fixing pin performs the function of the first end 21 in the present embodiment). When the charging door or the fuel door is closed, the locking and unlocking member 9 is in a locked state, and when the charging door or the fuel door is to be opened, the locked state of the locking and unlocking member 9 is released, and the guide member 3 then starts to move toward the outside of the vehicle.

The locking and unlocking member 9 may be a mechanical locking and unlocking member 9 operated by an external pressure of the vehicle, may be a locking and unlocking member 9 operated by control of a controller of the vehicle, or there is no special restriction as long as the purpose of unlocking is reached. In the present embodiment, a mechanical locking and unlocking member 9 operated by an external pressure of the vehicle is used.

Although a specific embodiment of the present disclosure has been described with reference to the above drawings, a person of ordinary skill in the art has to understand that the present disclosure can be implemented in other specific forms under a situation that does not change the technical idea or necessary features of the present disclosure. Accordingly, the embodiment is to be understood as non-limiting and illustrative.

### DESCRIPTION OF SYMBOLS

1: switch hinge structure used for charging door or fuel door of vehicle
2: structure housing
21: first end portion of structure housing
22: second end portion of structure housing
211: structure housing cover
24: first boss
3: guide member
31: groove track
4: first spring
5: rotation member
51: second boss
6: second spring
7: damping member
8: position limiting member
9: locking and unlocking member

What is claimed is:

1. A switch hinge structure used for a door of a vehicle, comprising:
a structure housing having an inner wall on which at least one first boss is disposed;
a guide member installed in the structure housing concentrically with the structure housing, the guide member including a first end disposed close to a first end portion of the structure housing, a second end connected to a cover of the door, and a groove track defined on an outer wall of the guide member;
a first spring installed in the structure housing to provide thrust to the guide member in a direction toward an outside of the vehicle;
a rotation member installed on a second end portion of the structure housing, having an annular shape, and having at least one second boss on an interior circumference thereof; and
a second spring connected to the rotation member, being in an energy storage state when the door is closed, and configured to drive the rotation member to provide torque to the guide member through the second boss when the door is opened,
wherein the first boss and the second boss are accommodated in and coupled with the groove track, and are configured to guide a movement of the guide member when the guide member moves out of the vehicle by an action of the first spring and the second spring.

2. The switch hinge structure used for the door of the vehicle of claim 1, wherein the first spring is configured such that,
when an elastic force of the first spring acts independently, the elastic force is set to be not sufficient to cause the guide member to move farthest from the first end using a guide of the groove track.

3. The switch hinge structure used for the door of the vehicle of claim 2, wherein the first spring and the second spring are configured such that,
when the elastic force of the first spring and an elastic force of the second spring act together, the guide member is set to move farthest from the first end using the guide of the groove track.

4. The switch hinge structure used for the door of the vehicle of claim 1, wherein
the first spring is a compression spring, an elastic coefficient of the first spring ranges from 20 to 25 gf·mm, and a compression length of the first spring ranges from 80 to 120 mm.

5. The switch hinge structure used for the door of the vehicle of claim 1, wherein
the second spring is a torsion spring, and an elastic coefficient corresponding to a torsion angle of each 1° ranges from 35 to 45 gf·mm.

6. The switch hinge structure used for the door of the vehicle of claim 1, wherein the groove track includes a straight track and a spiral track, and
wherein the straight track extends from a position close to the second end of the guide member on a side of the guide member to a position close to the first end of the guide member, and the spiral track extends spirally from the straight track to the first end of the guide member.

7. The switch hinge structure used for the door of the vehicle of claim 6, wherein
in an inner space of the structure housing,
the second boss is closer to the second end of the guide member than the first boss,
when the guide member moves while the first boss and the second boss are disposed on the straight track, an angle between the first boss and the second boss is 0°, and
when the guide member moves while at least one of the first boss and the second boss is disposed on the spiral track, the first boss on the inner wall of the structure housing does not move, and the angle between the first boss and the second boss changes according to a rotation of the rotation member.

8. The switch hinge structure used for the door of the vehicle of claim 6, wherein
the straight track is longer than the spiral track.

9. The switch hinge structure used for the door of the vehicle of claim 1, further comprising a structure housing cover and a damping member,
wherein the damping member is fixed to the structure housing cover and is coupled to the rotation member to adjust a rotation speed of the guide member.

10. The switch hinge structure used for the door of the vehicle of claim 9, wherein
teeth are disposed on a part of an exterior circumference of the rotation member, the damping member is a pinion gear type rotation damper including a pinion gear, and the teeth are combined with the rotation damper to adjust the rotation speed of the rotation member, thereby adjusting the rotation speed of the guide member.

11. The switch hinge structure used for the door of the vehicle of claim 1, further comprising a position limiting member defining a final position after the guide member moves.

12. The switch hinge structure used for the door of the vehicle of claim 11, wherein
the position limiting member is mounted in a position limiting member mount hole defined on the structure housing cover, an arc-shaped groove is included in the rotation member, and the arc-shaped groove is coupled with the position limiting member to define an initial position and a final position of the rotation member, to thereby define the final position after the movement of the guide member.

13. The switch hinge structure used for the door of the vehicle of claim 1, further comprising a locking and unlocking member,
wherein the locking and unlocking member is installed at the first end of the structure housing,
when the door is closed, the locking and unlocking member is in a locked state, and
when the door is to be opened, the locked state of the locking and unlocking member is released and the guide member starts to move toward the outside of the vehicle.
